(19) United States
(12) Patent Application Publication
(10) Pub. No.: US 2017/0089422 A1
(43) Pub. Date: Mar. 30, 2017

(54) PROPSHAFT LINER

(71) Applicant: GM GLOBAL TECHNOLOGY OPERATIONS LLC, Detroit, MI (US)

(72) Inventors: Steven W. Creek, Shelby Township, MI (US); David P. Schankin, Harrison Township, MI (US); Edralin S. Diaz, Troy, MI (US)

(21) Appl. No.: 14/865,255

(22) Filed: Sep. 25, 2015

(51) Int. Cl. F16F 15/10; F16C 3/02

(52) U.S. Cl. CPC F16F 15/10; F16C 3/02; F16C 2326/06; F16F 2224/0225

(57) ABSTRACT

A prop-shaft assembly comprises a hollow shaft having a center portion and end portions, an axially extending inner chamber, defined by an inner wall extending between the end portions, and a foam layer applied on the inner wall.

### FIELD OF THE INVENTION

The subject of the disclosure is related to the attenuation of noise and vibration generated by a rotating shaft and, more particularly, to a prop-shaft having an inner foam lining for the reduction of noise and vibration.

### BACKGROUND

Power transfer from rotating devices is commonly transferred through the use of prop-shafts; many of which are constructed of thin, hollow tubing. These prop-shafts are known to generate sound and vibrations which may be undesirable and, therefore, may require some form of attenuation. In vehicular applications, vehicle drivelines transmit rotational power from the powertrain (ex. engine and transmission) to the drive wheels. Noise generated from the driveline may be viewed by customers as annoying and therefore must be reduced or eliminated.

A common system and method for the reduction of noise and vibration in a vehicle prop-shaft is through the use of various damping devices which are inserted into the hollow prop-shaft at selected locations. The damping devices may be as simple as a cardboard sleeve and increase in complexity depending on the severity of the problem to be solved. Most of the damping devices are fixed in place utilizing a friction/press-fit, an adhesive or welding. A problem with such methods of securement is that they may have an effect on the material properties of the prop-shaft or may be unreliable. In addition, the ends of automotive prop-shafts are frequently formed in a rotary swaging operation and are necked down relative to the center portions of the prop-shaft. As a result, a problem is presented with the insertion of the afore-mentioned damping devices and methods of securement.

### SUMMARY OF THE INVENTION

In an exemplary embodiment a prop-shaft assembly comprising a hollow shaft having a center portion and end portions, an axially extending inner chamber defined by an inner wall extending between the end portions and a foam layer applied on the inner wall.

In another exemplary embodiment a vehicle comprises a powertrain assembly and a drive module coupled to the powertrain assembly by a driveshaft or prop-shaft assembly comprising a hollow shaft having a center portion, end portions, an axially extending inner chamber defined by an inner wall extending between the end portions and a foam layer applied on the inner wall.

The above features and advantages, and other features and advantages of the invention, are readily apparent from the following detailed description of the invention when taken in connection with the accompanying drawings.

### BRIEF DESCRIPTION OF THE DRAWINGS

Other features, advantages and details appear, by way of examples only, in the following detailed description of the embodiments, the detailed description referring to the drawings in which:

FIG. 1 is a schematic, plan view of a vehicle drivetrain embodying features of the invention;

FIG. 2 is a perspective view of an automotive prop-shaft embodying features of the invention;

FIG. 3 is a sectional view of the prop-shaft of FIG. 2 taken along line 3-3;

FIG. 4 is a partial, longitudinal sectional view of the prop-shaft of FIG. 2 taken along line 4-4; and

FIG. 5 is an enlarged partial, view of FIG. 3.

### DESCRIPTION OF THE EMBODIMENTS

The following description is merely exemplary in nature and is not intended to limit the present disclosure, its application or use. It should be understood that throughout the drawings, corresponding reference numerals indicate like or corresponding parts and features. As used herein the term vehicle is not limited to just an automobile, truck van or sport utility vehicle, but includes any self-propelled or towed conveyance suitable for transporting a burden.

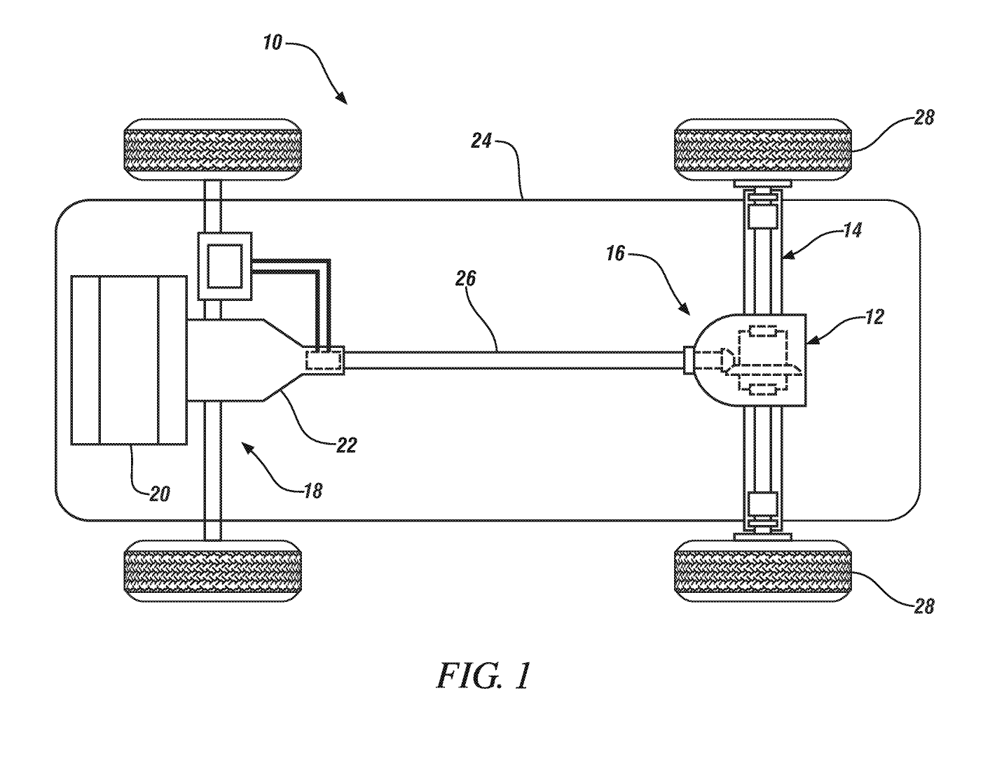

Referring now to FIG. 1 in an exemplary embodiment, a vehicle 10 is illustrated having a differential assembly 12 and an axle assembly 14 which are collectively referred to as a drive module 16. The vehicle 10 may include a powertrain assembly 18 that includes an engine 20, such as a gasoline or diesel fueled internal combustion engine. The engine 20 may further be a hybrid-type engine that combines an internal combustion engine with an electric drive-motor, for example. The engine 20 and the drive module 16 are coupled to a frame or other chassis structure 24. The engine 20 is coupled to the drive module 16 by a transmission 22 and a driveshaft or prop-shaft assembly 26. The transmission 22 is configured to vary the rotational velocity and the torque of the engine output. The modified output is transmitted to the drive module 16 via the drive shaft or prop-shaft assembly 26. The drive module 16 transmits the output from the prop-shaft assembly 26 through a differential gear set (not shown) to a pair of driven wheels 28 via axle assembly 14.

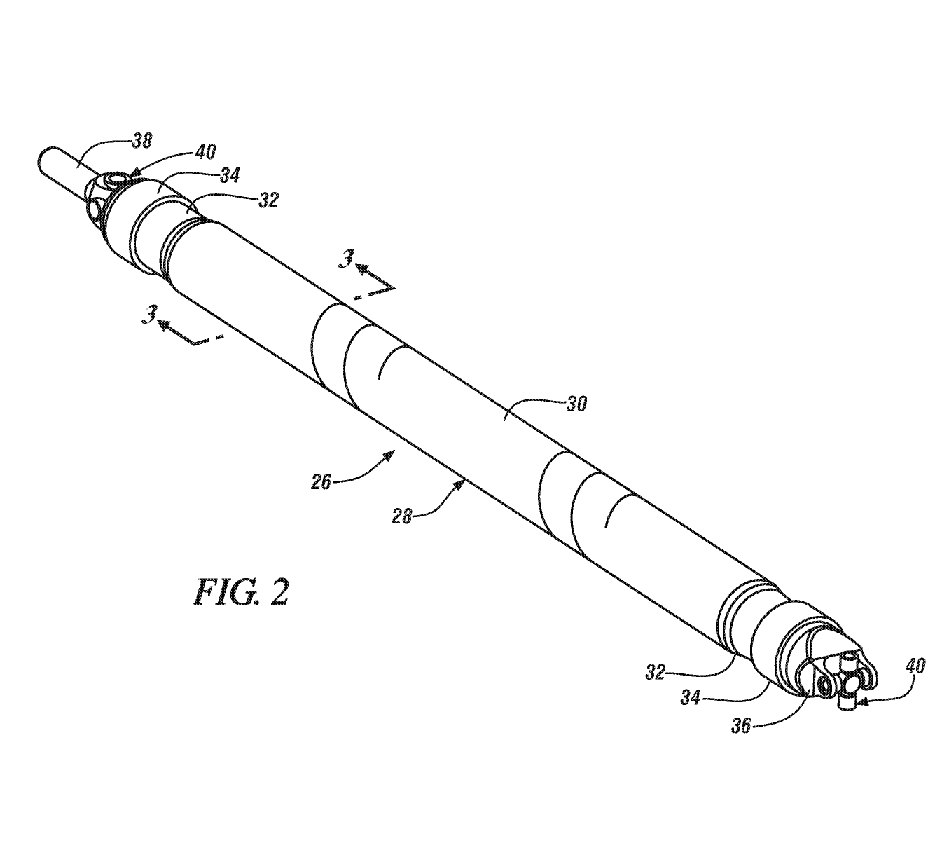

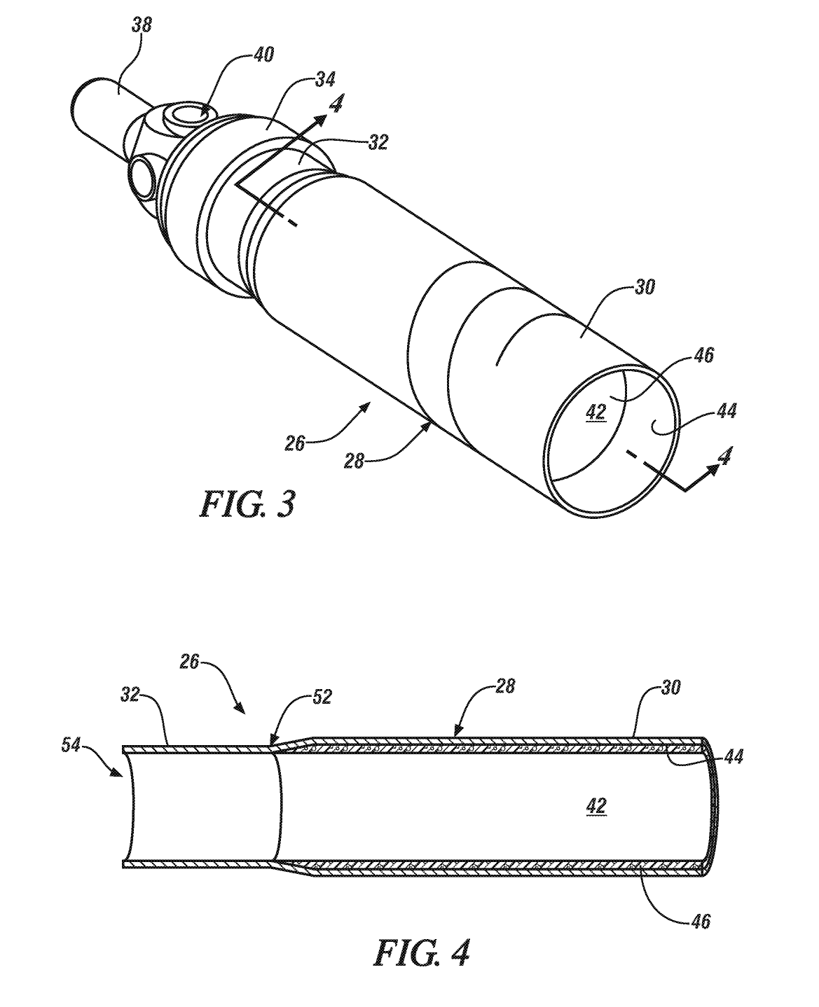

Referring now to FIGS. 2 through 4, in an embodiment, the prop-shaft assembly 26 comprises a hollow, thin-walled shaft 28 having a center portion 30 and end portions 32. The end portions 32 may be closed by trunnion caps 34 having spiders 36 extending therefrom for attachment to output shafts 38 of either the transmission 22 or the differential assembly 12 as universal joints 40, for example. The hollow, thin walled shaft has an axially extending inner chamber 42 defined by inner wall 44. During assembly of the prop-shaft assembly 26, a foam layer 46 is applied, such as by spraying or other suitable method of application, onto the inner wall 44. The foam layer 46 may extend the entire length of the hollow, thin walled shaft 28 or it may be sprayed onto pre-defined locations along the axial length of the inner wall 44 depending on the desired noise and vibration attenuation required of the particular prop-shaft assembly 26. In addition, the thickness of the foam layer 46 may also be varied from a thin layer to one that entirely fills the axially extending, inner chamber 42. The material used in the construction of the foam layer 46 may comprise one or more of a number of foams that are suitable for the application described. It is anticipated that, in one embodiment, the foam may comprise one of a sprayed polyurethane, polystyrene, polypropylene and polyethylene foam.

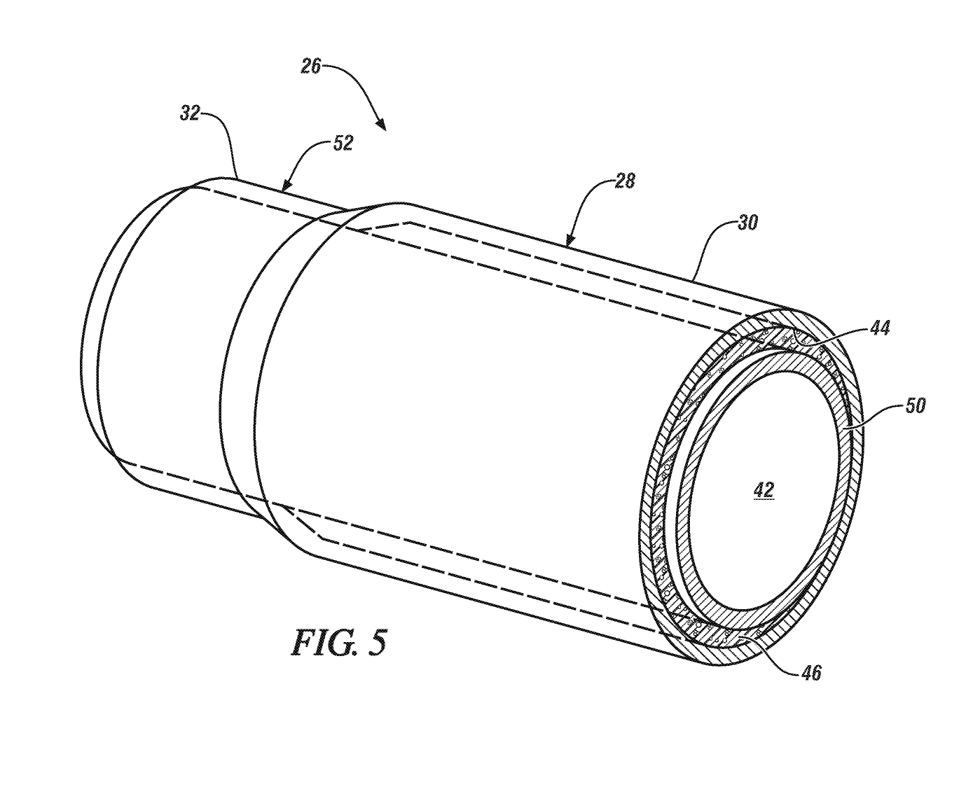

Referring now to FIGS. 4 and 5, in an embodiment, a prop-shaft assembly 26 has swaged or necked down portion 52 adjacent one or more of the end portions 32. As a result of the necked down portions 52, known liners and mass rings must have material properties that can be processed through the Aluminum or other material heat treating process without breakdown; as they must be inserted prior to the necking down process. The foam layer 46, however, may be applied following swaging or necking down and the Aluminum heat treat process of the hollow, thin-walled shaft 28. Following application of the foam layer 46, a desired mass inertia or liner 50 may be inserted into the shaft 20 through an opening 54 in an end portion 32 without regard to the reduced diameter of the necked-down portion 52. As the foam layer cures, the mass inertia or liner 50 will bond to the hardened foam resulting in a highly reliable and permanent positioning thereof without any effect on the material properties of the hollow, thin-walled shaft 28. It is anticipated that the mass inertia or liner 50 may extend from a localized area (10% of the length) up to the majority of the prop-shaft length inside of the welded ends.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation of material to the teachings of the invention without departing from the essential scope thereof. Therefore, it is intended that the invention not be limited to the particular embodiments disclosed, but that the invention will include all embodiments falling within the scope of the application.

What is claimed is:

1. A prop-shaft assembly comprising:
a hollow shaft having a center portion and end portions; and
an axially extending inner chamber defined by an inner wall extending between the end portions and a foam layer applied on the inner wall.

2. The prop-shaft of claim 1, wherein the foam layer is applied to the inner wall as a spray.

3. The prop-shaft of claim 1, wherein the foam layer extends the length of the hollow shaft.

4. The prop-shaft of claim 1, wherein the foam layer is applied onto pre-defined locations along the axial length of the inner wall.

5. The prop-shaft of claim 1, wherein the thickness of the foam layer may wary from a thin layer to one that entirely fills the axially extending, inner chamber.

6. The prop-shaft of claim 1, the foam layer comprising one of a sprayed polyurethane, polystyrene, polypropylene and a polyethylene foam.

7. The props-shaft of claim 1, further comprising a swaged or necked down portion adjacent one or more of the end portions.

8. The prop-shaft of claim 1, further comprising a mass inertia or liner inserted into the shaft through an opening in an end portion, wherein the mass inertia or liner bonds to the foam.

9. The prop-shaft of claim 8, wherein the mass inertia or liner extends from a localized area (10% of the length) up to the majority of the prop-shaft length inside of the welded ends.

10. A vehicle comprises:
a powertrain assembly; and
a drive module coupled to the powertrain assembly by a driveshaft or prop-shaft assembly comprising a hollow shaft having a center portion, end portions, an axially extending inner chamber defined by an inner wall extending between the end portions and a foam layer applied on the inner wall.

11. The vehicle of claim 10, wherein the powertrain assembly comprises an engine and a transmission, wherein the transmission is configured to vary rotational velocity and torque of the engine output and transmit it to the drive module via the drive shaft or prop-shaft assembly.

12. The vehicle of claim 10, wherein the foam layer is applied to the inner wall as a spray.

13. The vehicle of claim 10, wherein the foam layer extends the length of the hollow shaft.

14. The vehicle of claim 10, wherein the foam layer is applied onto pre-defined locations along the axial length of the inner wall.

15. The vehicle of claim 10, wherein the thickness of the foam layer may wary from a thin layer to one that entirely fills the axially extending, inner chamber.

16. The vehicle of claim 10, the foam layer comprising one of a sprayed polyurethane, polystyrene, polypropylene and a polyethylene foam.

17. The vehicle of claim 10, further comprising a swaged or necked down portion adjacent one or more of the end portions.

18. The vehicle of claim 10, further comprising a mass inertia or liner inserted into the shaft through an opening in an end portion, wherein the mass inertia or liner bonds to the foam.

19. The vehicle of claim 18, wherein the mass inertia or liner extends from a localized area (10% of the length) up to the majority of the prop-shaft length inside of the welded ends.
